(19) United States
(12) Patent Application Publication
(10) Pub. No.: US 2009/0215379 A1
(43) Pub. Date: Aug. 27, 2009

(54) Vehicular air-conditioning system

(75) Inventor: Shuji Matsunoo, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/380,275

(22) Filed: Feb. 25, 2009

(30) Foreign Application Priority Data
Feb. 27, 2008 (JP) 2008-045627

(51) Int. Cl. B60H 1/00

(52) U.S. Cl. 454/160

(57) ABSTRACT

A vehicular air-conditioning system shortened in the dimensions of the air-conditioning case in the vehicle front-rear direction and up-down direction dimensions, that is, a vehicular air-conditioning system in which first and second cool air bypass passages 15, 16 are formed making cool air from an evaporator 12 bypass a heater core 13, cool air from a first cool air bypass passage 15 and warm air from a heater core 13 are mixed in a front seat air mix chamber 17 and blown out to a front seat side in the vehicle interior, and cool air from a second cool air bypass passage 16 and warm air from the heater core 13 are mixed in a second air mix chamber 18 and below out to a rear seat side in the vehicle interior, wherein the heater core 13 is arranged so that air inflow/outflow surfaces extend in the vehicle up-down direction, the second cool air bypass passage 16 is made a tunnel-shaped passage running from part of the air outflow surface of the evaporator 12 to the rear seat air mix chamber 18, and the first and second cool air bypass passages 15, 16 are both formed at one of the top region or bottom region of the heater core 13.

### BACKGROUND OF THE INVENTION

1. Field of the Invention

The present invention relates to a vehicular air-conditioning system of an air-mix type adjusting a ratio of flow rates and a distribution of mixing of cool air and warm air to adjust vehicle interior venting temperature.

2. Description of the Related Art

In the past, various vehicular air-conditioning systems air-conditioning a plurality of different regions in the vehicle interior, specifically a front seat region and a rear seat region in the vehicle interior, by a single air-conditioning unit have been proposed (for example, see Japanese Patent Publication (A) No. 11-235914).

In this Japanese Patent Publication (A) No. 11-235914, an air passage at a downstream side of a cooling use heat exchanger arranged inside an air-conditioning case forming the air passage of the air-conditioning unit is divided into a front seat passage at the top of the vehicle and a rear seat passage at the bottom of the vehicle. A heating use heat exchanger is arranged along the divided passages, a front seat cool air bypass passage is formed above the heating use heat exchanger, and a rear seat cool air bypass passage is formed below it. Furthermore, the front seat passage is provided with a front seat air mix door, while the rear seat passage is provided with a rear seat air mix door. The air mix doors are independently operated to adjust the ratios of flow rates of the cold and warm air at the front seat passage and the rear seat passage so as to independently control the temperatures of the air vented to the front seat side and the rear seat side in the vehicle interior.

In this regard, the air-conditioning case of the air-conditioning unit is generally arranged below the instrument panel at the frontmost part of the vehicle. When, like in the air-conditioning case of Japanese Patent Publication (A) No. 11-235914, the front seat cool air bypass passage is formed at the top in the vehicle up-down direction and the rear seat cool air bypass passage is formed at the bottom sandwiching the heating use heat exchanger, the air-conditioning unit becomes longer in the vehicle up-down direction. Further, the rear seat cool air bypass passage is provided to extend from the air flow downstream side of the cooling use heat exchanger toward the bottom of the heating use heat exchanger. Space is necessary for the air inflow port of the rear seat cool air bypass passage between the cooling use heat exchanger and the heating use heat exchanger in the vehicle front-rear direction, so the air-conditioning unit becomes longer in the vehicle front-rear direction. For this reason, there was the problem that the air-conditioning unit could not be mounted when it was not possible to sufficiently secure its vehicle front-rear direction and up-down direction dimensions at the bottom part of the instrument panel.

Further, the rear seat cool air bypass passage is formed below the heating use heat exchanger, so at the air flow downstream side (air mix chamber) of the rear seat side air mix door, warm air can easily flow at the top and cool air at the bottom in the structure. For this reason, for example, if the rear seat vent openings consist of, at the top side in the vehicle up-down direction, rear seat face openings and, at the bottom side, rear seat foot openings, at the time of a bilevel mode when both the face opening and the foot opening blow out air etc., since warm air easily flows to the face side and cool air easily flows to the foot side, temperature control for obtaining a temperature distribution in the vehicle interior of the head cooling, foot warming type which passengers feel comfortable with was difficult.

### SUMMARY OF THE INVENTION

A first object of the present invention, in view of the above point, is to provide a vehicular air-conditioning system, which air-conditions a plurality of regions in a vehicle interior by a single air-conditioning unit, which shortens the vehicle front-rear direction and up-down direction dimensions of the air-conditioning case in the air-conditioning unit. Further, a second object of the present invention is to improve the temperature distribution in the vehicle interior at the rear seat region.

To achieve this object, in the aspect of the invention described in claim 1, there is provided a vehicular air-conditioning system provided with an air-conditioning case (11) forming an air passage through which air flows toward an inside of a vehicle interior, a cooling use heat exchanger (12) provided inside the air-conditioning case (11) and cooling air, a heating use heat exchanger (13) provided inside the air-conditioning case (11) and heating air cooled at the cooling use heat exchanger (12), first and second cool air bypass passages (15, 16) making cool air from the cooling use heat exchanger (12) bypass the heating use heat exchanger (13), a first air mix chamber (17) formed inside the air-conditioning case (11) and mixing cool air from the first cool air bypass passage (15) and warm air from the heating use heat exchanger (13), a first air mix means (19) provided inside the air-conditioning case (11) for adjusting a ratio of flow rates of cool air passing through the first cool air bypass passage (15) and warm air passing through the heating use heat exchanger (13) mixed at the first air mix chamber (17), a second air mix chamber (18) formed inside the air-conditioning case (11) at an air flow downstream side of the heating use heat exchanger (13) for mixing cool air from the second cool air bypass passage (16) and warm air from the heating use heat exchanger (13), a second air mix means (23) provided inside the air-conditioning case (11) for adjusting a ratio of flow rates of cool air passing through the second cool air bypass passage (16) and warm air from the heating use heat exchanger (13) mixed at the second air mix chamber (18), front seat vent openings (26, 28, 30) blowing air-conditioning air mixed at the first air mix chamber (17) toward the front seat side in the vehicle interior, and rear seat vent openings (32, 33) blowing air-conditioning air mixed at the second air mix chamber (18) toward the rear seat side in the vehicle interior, in which vehicular air-conditioning system, the heating use heat exchanger (13) being arranged so that an air inflow surface and air outflow surface extend in a vehicle up-down direction, the second cool air bypass passage (16) being comprised of a tunnel-shaped passage having a cool air inlet (16a) for introducing cool air from part of an air outflow surface of the cooling use heat exchanger (12) and a cool air outlet (16b) for guiding cool air introduced from the cool air inlet (16a) out to the second air mix chamber (18), and the first and second cool air bypass passages (15, 16) both being formed at one of a top region or bottom region of the heating use heat exchanger (13). Note that the notations in parentheses after the different means described in this section and the claims show the correspondence with specific means described in the later explained embodiments.

By making the second cool air bypass passage (16) a tunnel-shaped passage and forming both the first cool air bypass passage (15) and the second cool air bypass passage (16) at the top region or bottom region of the heating use heat exchanger (13) in the vehicle up-down direction in this way, compared with the case of forming the first and second cool air bypass passages (15, 16) divided in the up-down direction of the heating use heat exchanger (13), it is possible to shorten the dimensions of the air-conditioning case (11) in the up-down direction.

Further, since there is no need to secure space for an air inflow port of the second cool air bypass passage (16) between the cooling use heat exchanger (12) and the heating use heat exchanger (13), the dimensions of the air-conditioning case (11) in the vehicle front-rear direction can be shortened.

As a result, it is possible to shorten the vehicle front-rear direction and up-down direction dimensions of the air-conditioning case (11) in the air-conditioning unit (10). Here, the “vehicle up-down direction” includes not only the direction perpendicular to the horizontal direction, but also directions inclined from the horizontal direction.

Further, in the aspect of the invention described in claim 2, there is provided the aspect of the invention as set forth in claim 1 wherein the rear seat vent openings (32, 33) have a rear seat face opening (32) blowing out air toward a torso of a rear seat passenger and a rear seat foot opening (33) blowing out air toward a vicinity of the feet of a rear seat passenger, and the rear seat face opening (32) opens to a side nearer to a cool air outlet (16b) of the second cool air bypass passage (16) than the rear seat foot opening (33).

By making the rear seat face opening (32) open at the second cool air bypass passage (16) at the cool air outlet (16b) side in this way, cool air easily flows to the rear seat face opening (32) side and warm air easily flows to the rear seat foot opening (33) side at the time of the bilevel mode etc., so it is possible to make the temperature distribution in the vehicle interior a head cooling, foot warming type at the rear seat region. Therefore, it is possible to improve the temperature distribution in the vehicle interior at the rear seat region.

Further, in the aspect of the invention described in claim 3, there is provided the aspect of the invention as set forth in claim 1 or 2 wherein the air-conditioning case (11) is provided with a partition member (40) partitioning an inside of an air flow downstream side region of the heating use heat exchanger (13) and the first cool air bypass passage (15) into a left side region and a right side region in a vehicle width direction, the first and second air mix chambers (17, 18) are respectively formed at a left side region and a right side region partitioned by the partition member (40), the first and second air mix means (19, 23) are configured to be able to independently adjust the ratios of flow rates of the cool air and warm air mixed at the left side region and right side region of the first and second air mix chambers (17, 18), the front seat vent openings (26, 28, 30) are configured to respectively blow air-conditioning air mixed at the left side region and right side region of the first air mix chamber (17) to a left side region in the vehicle interior and a right side region in the vehicle interior, and the rear seat vent openings (32, 33) are configured to respectively blow air-conditioning air mixed at the left side region and right side region of the second air mix chamber (18) to a left side region in the vehicle interior and a right side region in the vehicle interior, and the partition member (40) is configured including the second cool air bypass passage (16).

By providing a vehicular air-conditioning system enabling independent air-conditioning of a left side region in the vehicle interior and a right side region in the vehicle interior in the vehicle width direction and forming part of the partition member (40) partitioning the inside of the air-conditioning case (11) into a left side region and a right side region by a common second cool air bypass passage (16) in this way, it is possible to reduce the size of the air-conditioning case (11) and keep down the increase in the number of parts of the air-conditioning unit (10).

Further, in the aspect of the invention described in claim 4, there is provided the aspect of the invention as set forth in any one of claims 1 to 3, wherein the first and second cool air bypass passages (15, 16) are formed in proximity to each other, and the second cool air bypass passage (16) is formed so that its passage cross-section becomes a flat shape and is formed so that two ends of the passage cross-section in the longitudinal direction become gradually smaller in passage cross-sectional area toward the front end.

Due to this, it is possible to keep the second cool air bypass passage (16) from creating flow resistance to the cool air flowing through the first cool air bypass passage (15) or warm air passing through the heating use heat exchanger (13).

### BRIEF DESCRIPTION OF THE DRAWINGS

These and other objects and features of the present invention will become clearer from the following description of the preferred embodiments given with reference to the attached drawings, wherein:

FIG. 1 is a schematic view of an air-conditioning unit according to a first embodiment;

FIG. 2 is a cross-sectional view along the line X-X in FIG. 1;

FIG. 3 is a schematic view of an air-conditioning unit at the time of a bilevel mode according to the first embodiment;

FIG. 4 is a schematic view of an air-conditioning unit according to a second embodiment;

FIG. 5 is a cross-sectional view along the line Y-Y in FIG. 4;

FIG. 6 is a cross-sectional view showing a passage cross-section of a second bypass passage according to a third embodiment; and

FIG. 7 is a cross-sectional view showing a passage cross-section of a second bypass passage according to another embodiment.

### DESCRIPTION OF THE PREFERRED EMBODIMENTS

### First Embodiment

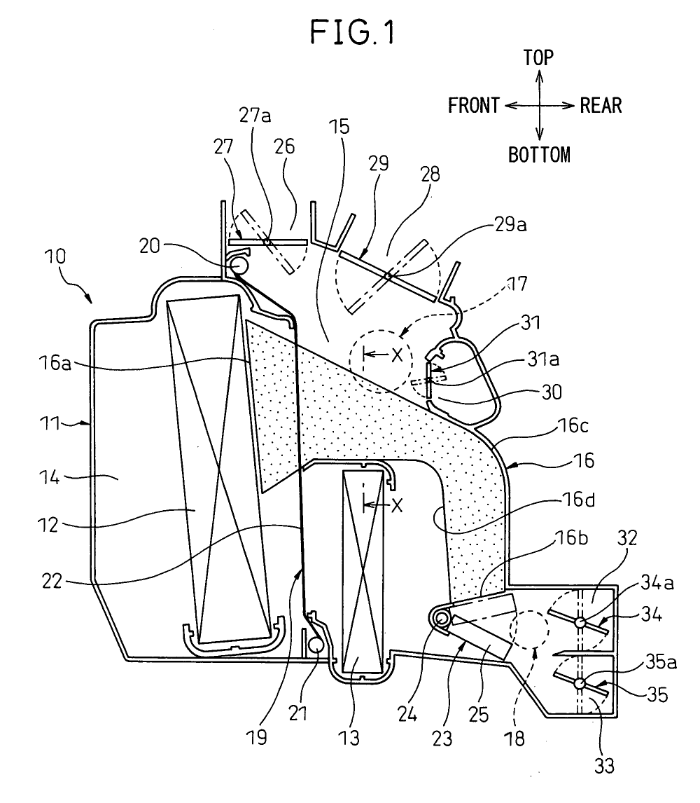

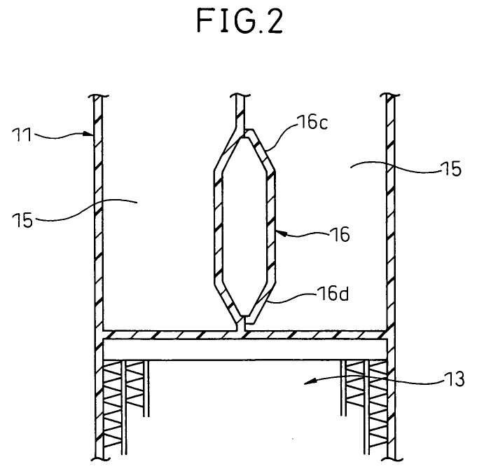

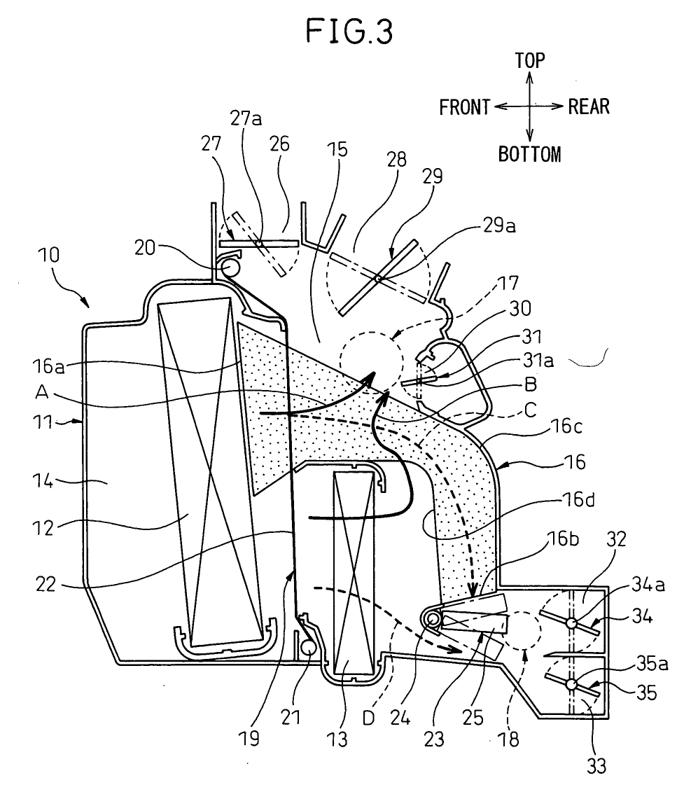

Below, a first embodiment of the present invention will be explained based on FIG. 1 to FIG. 3. Here, FIG. 1 is a schematic view of the inside of an air-conditioning unit in the present embodiment, FIG. 2 is a cross-sectional view along the line X-X in FIG. 1, and FIG. 3 is an explanatory view for explaining the operation of a vehicular air-conditioning system in the present embodiment.

An inside unit of the vehicular air-conditioning system according to this embodiment may be roughly divided into the two parts of an air-conditioning unit 10 shown in FIG. 1 and a blower unit (not shown) blowing air to this air-conditioning unit 10.

The blower unit is arranged behind an instrument panel (not shown) at the frontmost part of the vehicle interior offset from the center toward the front passenger seat side. As opposed to this, the air-conditioning unit 10 is arranged behind the instrument panel (not shown) at the frontmost part of the vehicle interior at the substantial center in the vehicle left-right (width) direction.

The blower unit, as is well known, has an inside/outside air switching box switching between outside air (air outside of the vehicle interior) and inside air (air inside the vehicle interior) and a centrifugal blower blowing air taken in through this inside/outside air switching box.

The air-conditioning unit 10 has a plastic air-conditioning case 11 forming an air passage through which air is blown toward the vehicle interior. This air-conditioning case 11 houses inside it both an evaporator 12 forming the cooling use heat exchanger and a heater core 13 forming the heating use heat exchanger. The air-conditioning unit 10 is arranged at the approximate center behind the instrument panel by the mounting direction shown by the arrow in FIG. 1 with respect to the vehicle front-rear direction and up-down direction.

At the portion inside the air-conditioning case 11 at the frontmost side of the vehicle is formed an air inlet space 14. Into this air inlet space 14, the blown air of the centrifugal blower of the blower unit flows. Inside the air-conditioning case 11, at the portion right after the air inlet space 14, the evaporator 12 is arranged.

This evaporator 12, as is well known, absorbs the latent heat of evaporation of a low pressure refrigerant of a refrigeration cycle so as to cool the blown air.

Furthermore, at the air flow downstream side (vehicle rear side) of the evaporator 12, the heater core 13 is arranged at a predetermined interval from the evaporator 12. The heater core 13 reheats the cool air passing through the evaporator 12. Inside it, high temperature hot water from a not shown vehicle engine (engine cooling water) flows. This hot water is used as a heat source to heat the air.

The heater core 13, as is well known, has a heat exchange use core comprised of flat tubes through which warm water passes and corrugated fins bonded with the same. At the bottom of this heat exchange use core, an inlet tank into which the warm water flows is arranged. At the top of this heat exchange use core, an outlet tank from which the warm water is made to flow out is arranged.

Here, the evaporator 12 is arranged in the air-conditioning case 11 so that the top portion is slanted to the front of the vehicle and is arranged so that air flows toward the rear of the vehicle.

As opposed to this, the heater core 13 is arranged so that the air inflow surface and air outflow surface extend in the vehicle up-down direction and is arranged so that at the vehicle rear side of the evaporator 12, the air flows toward the rear of the vehicle. Note that, in FIG. 1, the air inflow surface and air outflow surface of the heater core 13 are arranged to extend in the direction perpendicular to the horizontal direction, but may also be arranged to extend in a direction slanted with respect to the horizontal direction.

Furthermore, the heater core 13 is arranged to cut across only the bottom part of the air-conditioning case 11 in the air passage. At the top of the heater core 13, first and second cool air bypass passages 15, 16 are formed through which air (cool air) flows bypassing the heater core 13.

In the present embodiment, the first and second cool air bypass passages 15 and 16 are formed so as to be in proximity to each other. Note that the second cool air bypass passage 16 and the heater core 13 are formed to be in proximity, but the second cool air bypass passage 16 and the heater core 13 may also be formed separated from each other.

The first cool air bypass passage 15 is formed at the air flow downstream side of the heater core 13 so as to communicate with a front seat air mix chamber (first air mix chamber) 17 formed at the top in the air-conditioning case 11.

The front seat air mix chamber 17 is a mixing region of the cool air and the warm air mixing the cool air passing through the first cool air bypass passage 15 and the warm air passing through the heater core 13. The air-conditioning air mixed in the front seat air mix chamber 17 flows to the later explained front seat vent openings 26, 28, and 30.

On the other hand, the second cool air bypass passage 16 (shaded portion in FIG. 1) is formed at the center position of the vehicle width direction (direction perpendicular to paper surface) in the air-conditioning case 11 so as to divide part of the first cool air bypass passage 15 to a left side region and a right side region. Furthermore, the second cool air bypass passage 16 is formed from the top of the air outflow surface of the evaporator 12 at the air flow downstream side of the heater core 13 so as to communicate with a rear seat air mix chamber (second air mix chamber) 18 formed at the bottom of the air-conditioning case 11.

Specifically, the second cool air bypass passage 16 is comprised of a tunnel-shaped passage bent to an L-shape, extending from the top of the air outflow surface of the evaporator 12 toward the vehicle rear side, and extending to the bottom along the rear surface formed at the air flow downstream side of the heater core 13 at the air-conditioning case 11.

Furthermore, the second cool air bypass passage 16 is comprised having a cool air inlet 16a opening at the top portion of the air outflow surface of the evaporator 12 so as to introduce cool air and a cool air outlet 16b opening at the rear seat air mix chamber 18 so as to guide out cool air.

As shown in FIG. 2, the second cool air bypass passage 16 is formed with a passage cross-section of a vertically long flat shape. Further, the second cool air bypass passage 16 is formed to a tapered shape where the passage cross-sectional areas of the top end 16c and bottom end 16d in the longitudinal direction of the passage cross-section become gradually smaller from the center. This is so as to keep the second cool air bypass passage 16 from creating a flow resistance to the cool air flowing through the first cool air bypass passage 15 and the warm air passing through the heater core 13.

Specifically, this is to make the warm air passing through the heater core 13 divide near the bottom end 16d of the second cool air bypass passage 16 without rapidly changing in flow direction. Further, this is to make the cool air passing through the right side region and the left side region formed at part of the first cool air bypass passage 15 or the warm air passing through the heater core 13 divide near the top end 16c of the second cool air bypass passage 16 without rapidly changing in flow direction.

Returning to FIG. 1, the rear seat air mix chamber 18 is a mixing region of the cool air and the warm air mixing the cool air passing through the second cool air bypass passage 16 and the warm air passing through the heater core 13. The air-conditioning air mixed in the rear seat air mix chamber 18 flows to the later explained rear seat vent openings 32, 33.

In the air-conditioning case 11 between the evaporator 12 and the heater core 13, a front seat air mix door (first air mix door) 19 is provided for adjusting the ratio of flow rates of the cool air and the warm air mixed at the front seat air mix chamber 17 and adjusts the temperature of the air-conditioning air flowing through the later explained front seat vent openings 26, 28, and 30.

This front seat air mix door 19 is comprised of a known film door made of a film-shaped member with two ends fixed to and wound up at a drive shaft 20 and driven shaft 21 rotatably supported at the air-conditioning case 11.

The film-shaped member 22 is provided to be able to slide in the vehicle up-down direction in a state given a certain tension by the drive shaft 20 and the driven shaft 21 so as to cut across the air flow upstream side of the air inflow surface of the heater core 13 and the first cool air bypass passage 15. Here, the drive shaft 20 is driven by a step motor or other drive means (not shown). The rotation of this drive shaft 20 is transmitted through a rotation transmission mechanism to the driven shaft 21.

Further, the film-shaped member 22 is formed with a plurality of openings (not shown). By making the drive shaft 20 rotate in the forward and reverse directions and stopping the openings at any positions, the ratio of flow rates of the air flowing into the first cool air bypass passage 15 and the air flowing into the heater core 13 is adjusted.

Further, in the present embodiment, the second cool air bypass passage 16 is formed at a center position of the air-conditioning case 11 in the vehicle left-right direction so as to extend from the top of the air outflow surface of the evaporator 12 toward the vehicle rear side, so the center of the film-shaped member 22 in the vehicle left-right direction is formed with a hole (not shown) for avoiding interference with the second bypass passage 16.

Further, inside the air-conditioning case 11 at the air flow downstream side of the heater core 13 and the bottom of the vehicle up-down direction, a rear seat air mix door (second air mix door) 23 is provided for adjusting the ratio of flow rates of the cool air and the warm air mixed at the rear seat air mix chamber 18. This adjusts the temperature of the air-conditioning air flowing through the later explained rear seat vent openings 32, 33.

The rear seat air mix door 23 is comprised of a flat plate shaped door 25 rotatably supported about the shaft 24. The shaft 24 is driven by a servo motor or other drive means (not shown). Further, the rear seat air mix door 23 is comprised so as to be able to open and close the cool air outlet 16b of the second cool air bypass passage 16 and to enable warm air from the heater core 13 to be introduced to and blocked from entering the rear seat air mix chamber 18.

Next, at the air flow downstream end of the air passage of the air-conditioning case 11, a plurality of vent openings are formed. At the downstream side of this plurality of vent openings, vent ducts (not shown) for blowing air-conditioning air toward predetermined locations in the vehicle interior are connected.

Among this plurality of vent openings, the defroster opening 26 is provided at the top surface of the air-conditioning case 11 at the vehicle front side and is communicated through a defroster duct (not shown) to defroster vents (not shown) for blowing air-conditioning air out into the vehicle interior toward the front windshield. The defroster opening 26 is provided with a plate-shaped defroster opening/closing door 27 able to rotate about a shaft 27a.

Further, the face opening 28 is provided at the top surface of the air-conditioning case 11 at the vehicle rear side. The face opening 28 is provided with a plate-shaped face opening/closing door 29 able to rotate about a shaft 29a. The face opening 28 is communicated through a face duct (not shown) to face vents (not shown) blowing air-conditioning air toward the torsos of front seat passengers in the vehicle interior.

Further, the foot opening 30 is provided toward the vehicle rear side from the face opening 28 at the top side of the rear surface of the air-conditioning case 11. It is communicated through a foot duct (not shown) to foot vents (not shown) blowing air-conditioning air toward the feet of the front seat passengers in the vehicle interior. The foot opening 30 is provided with a plate-shaped foot opening/closing door 31 able to rotate about a shaft 31a.

The defroster opening 26, the face opening 28, and the foot opening 30 form the front seat vent openings for blowing out air-conditioning air toward the front seat passengers. On the other hand, the rear seat vent openings are comprised of the rear seat face opening 32 and the rear seat foot opening 33. These are provided at the bottommost side of the rear surface of the air-conditioning case 11.

Here, the rear seat face opening 32 and the rear seat foot opening 33 are provided with a plate-shaped rear seat face opening/closing door 34 and rear seat foot opening/closing door 35 rotatable about shafts 34a, 35a.

The rear seat face opening 32 is communicated through a rear seat face duct (not shown) to rear seat face vents (not shown) for blowing out air-conditioning air toward the torsos of the rear seat passengers, while the rear seat foot opening 33 is communicated through a rear seat foot duct (not shown) to rear seat foot vents (not shown) for blowing air-conditioning air toward the feet of the rear seat passengers.

Here, the rear seat face opening 33 is formed above the rear seat foot opening 32 in the vehicle up-down direction. The rear seat face opening 32 and the cool air outlet 16b of the second cool air bypass passage 16 are formed closer compared with the rear seat foot opening 33.

That is, the rear seat face opening 32 is formed so that cool air passing through the second cool air bypass passage 16 easily flows into it. Further, the rear seat foot opening 33 is formed so that the warm air passing through the heater core 13 easily flows into it.

The vent mode doors of the front seat vent opening and the rear seat vent opening (opening/closing doors) are coupled through a link mechanism (not shown) to an output shaft of a servo motor of a common actuator. Therefore, this common actuator mechanism can be used to operate the vent mode doors interlocked. This link mechanism, actuator, etc. configure a vent mode switching device which is controlled by a control device (not shown).

Next, the operation of the present embodiment in the above configuration will be explained. In the present embodiment, as shown in FIG. 3, the case where the vent mode switching device is used to open the face opening 28 and foot opening 30 and the rear seat face opening 32 and rear seat foot opening 33 and switch to the bilevel mode blowing air-conditioning air toward the torsos and near the feet of the front seat and rear seat passengers will be explained.

Here, the front seat air mix door 19 half opens the air inflow surface of the heater core 13 and first cool air bypass passage 15. Further, the rear seat air mix door 23 half opens the second cool air bypass passage 16. Due to this, they are set to the intermediate temperature positions.

When, in the state where the vent mode switching device sets the system to the bilevel mode, the blower unit and refrigeration cycle are operated, air blown from the blower unit flows into the air inlet space 14 at the frontmost part of the air-conditioning case 11, then is cooled by the evaporator 12 and becomes cool air.

Furthermore, the cool air cooled at the evaporator 12 is divided into air passing through the first cool air bypass passage 15, air passing through the second cool air bypass passage 16, and air flowing into the heater core 13.

The cool air passing through the first cool air bypass passage 15 (solid arrow A in the figure) and the warm air passing over the top of the heater core 13 (solid arrow B in the figure) are mixed at the front seat air mix chamber 17 and flow to the face opening 28 and foot opening 30.

Here, the cool air passing through the first cool air bypass passage 15 (solid arrow A in the figure) and the warm air passing over the top of the heater core 13 (solid arrow B in the figure) are divided and merged by the second cool air bypass passage 16, but the top end 16c and bottom end 16d of the second cool air bypass passage 16 are tapered in shape so that the directions of air flows of the cool air and the warm air do not rapidly change, so it is possible to suppress flow resistance caused by the second cool air bypass passage 16.

On the other hand, the cool air passing through the second cool air bypass passage 16 (broken line arrow C in the figure) and the warm air passing through the heater core 13 (broken line arrow D in the figure) are mixed at the rear seat air mix chamber 18 and flow to the rear seat face opening 32 and the rear seat foot opening 33.

Here, the rear seat face opening 32 is designed to enable easy inflow of cool air passing through the second cool air bypass passage 16, while the rear seat foot opening 33 is designed to enable easy inflow of warm air passing through the heater core 13. For this reason, in the bilevel mode, it is possible to obtain a temperature distribution in the vehicle interior of a head cooling, foot warming type at the rear seat region.

As explained above, according to the vehicular air-conditioning system described in the present embodiment, by making the second cool air bypass passage 16 a tunnel-shaped passage and forming both the first cool air bypass passage 15 and the second cool air bypass passage 16 at the top region or the bottom region in the heater core 13 at the vehicle up-down direction, it is possible to shorten the dimensions of the air-conditioning case 11 in the up-down direction compared with the case of forming the first and second cool air bypass passages 15, 16 divided in the up-down direction of the heater core 13.

Furthermore, since there is no need to secure space for an air inflow port of the second cool air bypass passage 16 between the evaporator 12 and the heater core 13, the dimensions of the air-conditioning case 11 in the vehicle front-rear direction can be shortened.

As a result, it is possible to shorten the vehicle front-rear direction and up-down direction dimensions of the air-conditioning case 11 in the air-conditioning unit 10.

Further, by making the rear seat face opening 32 open at the second cool air bypass passage 16 at the cool air outlet 16b side in this way, in the bilevel mode, it is possible to make the temperature distribution in the vehicle interior a head cooling, foot warming type at the rear seat region. Therefore, it is possible to improve the temperature distribution in the vehicle interior at the rear seat region.

Further, by forming the passage cross-section of the second cool air bypass passage 16 into a vertically long flat shape and forming the top end 16c and the bottom end 16d of the passage cross-section into a tapered shape, it is possible to keep the second cool air bypass passage 16 from creating a flow resistance to the cool air flowing through the first cool air bypass passage 15 and the warm air passing through the heater core 13.

### Second Embodiment

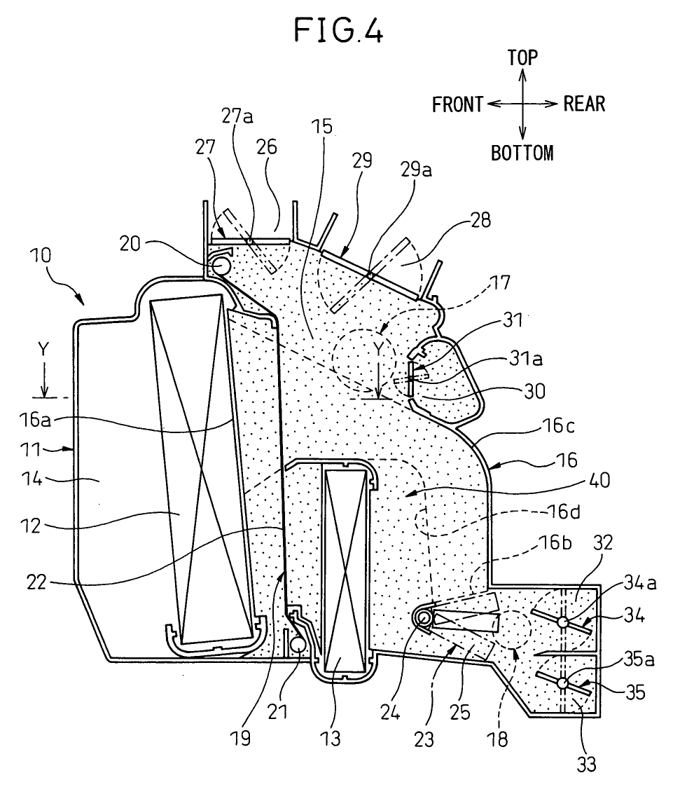

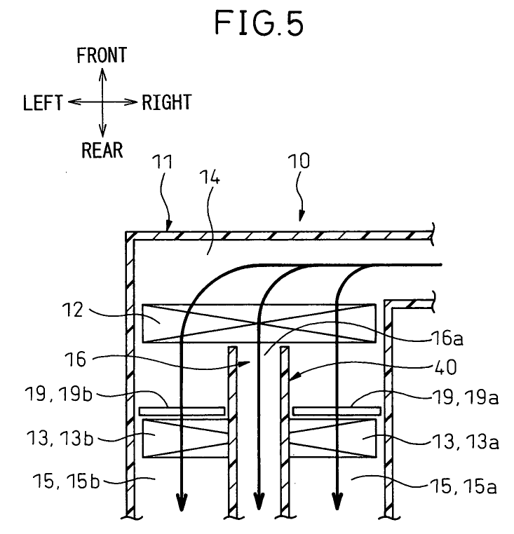

Next, a second embodiment of the present invention will be explained based on FIG. 4 and FIG. 5. Parts similar to or equal with the first embodiment are assigned the same reference notations and explanations thereof will be omitted. Here, FIG. 4 is a schematic view of an air-conditioning unit in the present embodiment, while FIG. 5 is a cross-sectional view along the line Y-Y of FIG. 4.

In the present embodiment, as shown in FIG. 4, at the center position of the vehicle width direction inside the air-conditioning case 11, a center partition member (partition member) 40 (shaded portion in FIG. 4) is provided extending from the air outflow surface of the evaporator 12 to the openings and extending in the vehicle up-down direction.

This center partition member 40 partitions the inside of the air-conditioning case 11 downstream of the evaporator 12 in the air flow into a vehicle right side region and a vehicle left side region. Further, the vehicle right side region and the vehicle left side region partitioned by the center partition member 40 are provided with, independently for the respective regions, a first cool air bypass passage 15, front seat air mix chamber 17, rear seat air mix chamber 18, front seat air mix door 19, rear seat air mix door 23, etc.

For example, as shown in FIG. 5, in the air-conditioning case 11, a vehicle right side region 15a and a vehicle left side region 15b of the first cool air bypass passage 15 are formed separated by the center partition member 40, a vehicle right side region 13a and vehicle left side region 13b of the heater core 13 are formed, and the front seat air mix door 19 is provided with a vehicle right side door 19a and a vehicle left side door 19b.

Further, the front seat openings 28, 30 and the rear seat openings 32, 33 are partitioned into the vehicle right side region and vehicle left side region. Air-conditioning air is blown out through the ducts from the vehicle right side vent and the vehicle left side vent.

The front seat air mix door 19 and the rear seat air mix door 23 provided at the vehicle right side region and the vehicle left side region are configured to be independently controllable so the temperatures of the air-conditioning air blown out to the left and right regions of the vehicle interior can be independently controlled thereby forming an independent left-right temperature control system.

Furthermore, the center partition member 40 is comprised including the second cool air bypass passage 16. That is, the center partition member 40 is formed with a tunnel-shaped passage extending from the top of the air outflow surface of the evaporator 12 toward the vehicle rear side and extending downward along the rear surface of the air-conditioning case 11 formed at the air flow downstream side of the heater core 13 (broken line part inside center partition member 40 in FIG. 4).

In this way, in a vehicular air-conditioning system of an independent left-right temperature control type enabling the left side region in the vehicle interior and the right side region in the vehicle interior in the vehicle width direction to be independently air-conditioned, by forming a second cool air bypass passage 16 at part of the center partition member 40 partitioning the inside of the air-conditioning case 11 into a vehicle left side region and a vehicle right side region and making common use of the center partition member 40 and the second cool air bypass passage 16, it is possible to make the size of the air-conditioning case 11 smaller and keep down the increase in the number of parts of the air-conditioning unit 11.

### Third Embodiment

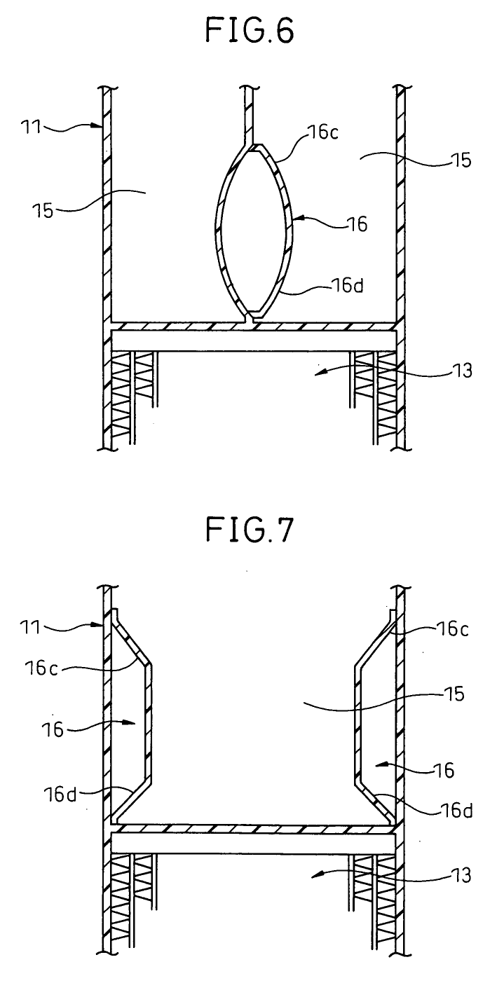

Next, a third embodiment of the present invention will be explained based on FIG. 6. Parts similar to or equal with the first embodiment are assigned the same reference notations and explanations thereof will be omitted. Here, FIG. 6 is a cross-sectional view including a passage cross-section of the second cool air bypass passage in the present embodiment.

In the first embodiment, the passage cross-section of the second cool air bypass passage 16 is formed to a vertically long flat shape and the top end 16c and bottom end 16d in the longitudinal direction of the passage cross-section are formed into tapered shapes so as to become gradually smaller compared with the center.

In the present embodiment, as shown in FIG. 6, the passage cross-section of the second cool air bypass passage 16 is formed to an elliptical shape so as to become a vertically long flat shape and the top end 16c and bottom end 16d in the longitudinal direction of the passage cross-section are formed so as to become gradually smaller compared with the center.

Due to this as well, the second cool air bypass passage 16 can be kept from creating a flow resistance to the cool air flowing through the first cool air bypass passage 15 and warm air passing through the heater core 13.

### Other Embodiments

The present invention is not limited to the above embodiments and may also be modified in various ways as explained below.

(1) In the above embodiments, the second cool air bypass passage 16 is formed at the center position of the vehicle width direction (direction perpendicular to the paper surface) in the air-conditioning case 11 so as to divide part of the first cool air bypass passage 15 into a left side region and a right side region, but the invention is not limited to this.

For example, as shown in FIG. 7, the second cool air bypass passage 16 may be formed at the two side walls of the vehicle width direction of the air-conditioning case 11 and the first cool air bypass passage 15 may be formed at the center position in the vehicle width direction. Further, it is also possible to provide openings right after the evaporator 12 and at the side walls of the rear seat air mix chamber 18 in the vehicle width direction of the air-conditioning case 11 and arrange a tunnel-shaped second cool air bypass passage 16 so as to connect these openings.

(2) Further, in the above embodiments, the second cool air bypass passage 16 is formed above the heater core 13 along with the first cool air bypass passage 15, but the second cool air bypass passage 16 and the first cool air bypass passage 15 may also be formed below the heater core 13. Note that, in this case, the heater core 13 is arranged so as to cut across the top of the inside of the air passage of the air-conditioning case 11.

(3) Further, in the above embodiments, the front seat air mix door 19 is configured by a film door, but the invention is not limited to this. It may also be configured by a plate door or other door means. Similarly, the rear seat air mix door 23 and the opening/closing door for switching vent modes are configured by plate doors, but the invention is not limited to this. They may also be configured by film doors or other door means.

While the invention has been described with reference to specific embodiments chosen for purpose of illustration, it should be apparent that numerous modifications could be made thereto by those skilled in the art without departing from the basic concept and scope of the invention.

1. A vehicular air-conditioning system provided with:
an air-conditioning case forming an air passage through which air flows toward an inside of a vehicle interior,
a cooling use heat exchanger provided inside said air-conditioning case and cooling air,
a heating use heat exchanger provided inside said air-conditioning case and heating air cooled at said cooling use heat exchanger,
first and second cool air bypass passages making cool air from said cooling use heat exchanger bypass said heating use heat exchanger,
a first air mix chamber formed inside said air-conditioning case and mixing cool air from said first cool air bypass passage and warm air from said heating use heat exchanger,
a first air mix means provided inside said air-conditioning case for adjusting a ratio of flow rates of cool air passing through said first cool air bypass passage and warm air passing through said heating use heat exchanger mixed at said first air mix chamber,
a second air mix chamber formed inside said air-conditioning case at an air flow downstream side of said heating use heat exchanger for mixing cool air from said second cool air bypass passage and warm air from said heating use heat exchanger,
a second air mix means provided inside said air-conditioning case for adjusting a ratio of flow rates of cool air passing through said second cool air bypass passage and warm air from said heating use heat exchanger mixed at said second air mix chamber,
front seat vent openings blowing air-conditioning air mixed at said first air mix chamber toward the front seat side in the vehicle interior, and
rear seat vent openings blowing air-conditioning air mixed at said second air mix chamber toward the rear seat side in the vehicle interior,
in said vehicular air-conditioning system,
said heating use heat exchanger being arranged so that an air inflow surface and air outflow surface extend in a vehicle up-down direction,
said second cool air bypass passage being comprised of a tunnel-shaped passage having a cool air inlet for introducing cool air from part of an air outflow surface of said cooling use heat exchanger and a cool air outlet for guiding cool air introduced from said cool air inlet out to said second air mix chamber, and
said first and second cool air bypass passages both being formed at one of a top region or bottom region of said heating use heat exchanger.

2. A vehicular air-conditioning system as set forth in claim 1, wherein
said rear seat vent openings have a rear seat face opening blowing out air toward a torso of a rear seat passenger and a rear seat foot opening blowing out air toward a vicinity of the feet of a rear seat passenger, and
said rear seat face opening opens to a side nearer to a cool air outlet of said second cool air bypass passage than said rear seat foot opening.

3. A vehicular air-conditioning system as set forth in claim 1, wherein
said air-conditioning case is provided with a partition member partitioning an inside of an air flow downstream side region of said heating use heat exchanger and said first cool air bypass passage into a left side region and a right side region in a vehicle width direction,
said first and second air mix chambers are respectively formed at a left side region and a right side region partitioned by said partition member,
said first and second air mix means are configured to be able to independently adjust the ratios of flow rates of the cool air and warm air mixed at the left side region and right side region of said first and second air mix chambers,
said front seat vent openings are configured to respectively blow air-conditioning air mixed at the left side region and right side region of said first air mix chamber to a left side region in the vehicle interior and a right side region in the vehicle interior, and
said rear seat vent openings are configured to respectively blow air-conditioning air mixed at the left side region and right side region of said second air mix chamber to a left side region in the vehicle interior and a right side region in the vehicle interior, and
said partition member is configured including said second cool air bypass passage.

4. A vehicular air-conditioning system as set forth in claim 1, wherein
said first and second cool air bypass passages are formed in proximity to each other, and
said second cool air bypass passage is formed so that its passage cross-section becomes a flat shape and is formed so that two ends of the passage cross-section in the longitudinal direction become gradually smaller in passage cross-sectional area toward the front end.
